(19) United States
(12) Patent Application Publication
(10) Pub. No.: US 2023/0142946 A1
(43) Pub. Date: May 11, 2023

(54) AN ALCOHOL TOLERABLE ACRYLATE POLYMER AND ITS APPLICATION

(71) Applicant: BASF SE, Ludwigshafen am Rhein (DE)

(72) Inventors: Li LI, Shanghai (CN); Yan MEI, Shanghai (CN)

(21) Appl. No.: 17/918,618

(22) PCT Filed: Jun. 29, 2021
(86) PCT No.: PCT/EP2021/067917

§ 371 Date: Oct. 13, 2022

(30) Foreign Application Priority Data
Jul. 10, 2020 (CN) PCT/CN2020/101248

(51) Int. Cl. C09D 133/12; C09D 11/00; C09D 125/14

(52) U.S. Cl. CPC C09D 133/12; C09D 11/00; C09D 125/14

(57) ABSTRACT

Described herein is a waterborne emulsion, a method for making the waterborne emulsion, and an application of the waterborne emulsion as a binder for inks. The waterborne emulsion includes an acidic polymer stabilizer and a base polymer. The ink made using the waterborne emulsion shows excellent alcohol tolerance and wet wrinkle resistance.

### FIELD OF INVENTION

The present invention is related to a waterborne emulsion, a method for making such and its application as binders for inks.

### BACKGROUND OF THE INVENTION

Waterborne inks, coatings, and adhesives are commonly applied to a variety of substrates including plastic films, paper, metal, concrete and board stock. They are more environmentally friendly compared to solvent-borne systems which tend to have a substantial content of volatile organic compounds (VOCs). However, waterborne systems have some deficiencies, such as the lack of adhesion, low resistance to water and not tolerable with alcoholic solvents such as isopropanol, ethanol, oils, greases, solvents, etc. One reason for this is the nature of the composition of the ink or coating system. Typically, waterborne systems include emulsion polymers supported by surfactants. The presence of these surfactants (necessary for forming a stable emulsion) in small quantities deteriorates the adhesion and/or resistance properties of the final dried ink/coating.

Many technical solutions have been proposed to solve the abovementioned issues. For example, US20090270517A1 discloses an emulsion with tolerance to alcohol comprising a monohydric alcohol or a solution in a monohydric alcohol as a solvent; and an emulsifier; wherein (1) the content of the monohydric alcohol or the solution thereof being 10 wt % or more, based on the total weight of the emulsion; (2) the content of the emulsifier being 0.1 to 50 wt %, based on the total weight of the emulsion; and (3) the emulsion being in the form of an O/W emulsion, W/O/W emulsion, O/W/O emulsion, or S/O/W emulsion. In this application, special emulsifier was used.

Alternatively, the emulsion polymerization may be supported using acid functional protective polymer colloids in place of surfactants. These improve resistance properties and also provide additional benefits such as resolubility (the ability of the press to recover print after the press has stopped) of the inks on the press. For example, WO2013177435A2 disclosed the use of hydrophilic, low acid content polymers as stabilizers for water-based emulsions. Unfortunately, for certain applications such as printing inks on films, the resistance, adhesion and flexibility properties are still not sufficient. In addition, such emulsion also has low tolerance to alcohol.

For many ink applications, alcohols are formulated together with the waterborne emulsions and the ink formulations are often applied onto many flexible substrates. Therefore, there is still a need to find more suitable waterborne emulsions that exhibits high tolerance to alcohol and outstanding wet wrinkle performance (i.e. balanced performance in terms of water resistance, adhesion and flexibility).

### SUMMARY OF THE INVENTION

It was an object of the invention to provide a waterborne emulsion that exhibits high tolerance to alcohol and outstanding wet wrinkle performance.

One objective of the present invention is to provide a waterborne emulsion comprising:
A) An acidic polymer stabilizer with a weight average molecular weight (Mw) in the range of 4,000 to 18,000, an acid value (AV) in the range of 60 to 200 and an oxygen content of at least 15 wt %,
B) A base polymer with an oxygen content of at least 12 wt %;

Wherein the acidic polymer may be presented in the range of 20 wt % to 70 wt %, based on the total dry weight of the waterborne emulsion, and the theoretical acid value (TAV) of the waterborne emulsion is in the range of 15 to 60.

Another objective of the present invention is to provide a process to make the waterborne emulsion.

A third object objective of the present invention is to provide an ink formulation containing the waterborne emulsion.

### DETAILED DESCRIPTION OF THE INVENTION

Unless otherwise specified, all terms/terminology/nomenclatures used herein have the same meaning as commonly understood by the skilled person in the art to which this invention belongs to.

Expressions “a”, “an” and “the”, when used to define a term, include both the plural and singular forms of the term.

The term “polymer” or “polymers”, as used herein, includes both homopolymer(s), that is, polymers prepared from a single reactive compound, and copolymer(s), that is, polymers prepared by reaction of at least two polymer forming reactive, monomeric compounds.

The designation (meth)acrylate and similar designations are used herein as an abbreviated notation for “acrylate and/or methacrylate”.

All percentages and ratios denote weight percentages and weight ratios unless otherwise specified.

The term weight average molecular weight (Mw) means a molecular weight measured by Gel Permeation Chromatography (GPC) against polystyrene standard in tetrahydrofuran with the unit of g/mol.

The term oxygen content of a polymer refers to the weight ratio of oxygen atoms in the respective polymer.

The term acid value (AV) refers to the acid number reported in mg KOH (base) per g of the resin, determined by titration of the bulk resin dissolved in tetrahydrofuran (THF) with a 0.1N KOH aqueous solution. And the term theoretical acid value (TAV) refers the theoretical acid number as calculated with the following equation:

TAV=AV_{acid polymer}*(weight percentage of the acid polymer over the total weight of the emulsion)+AV_{base polymer}*(weight percentage of the base polymer over the total weight of the emulsion).

One objective of the present invention is to provide a waterborne emulsion comprising:
A) An acidic polymer stabilizer with a weight average molecular weight (Mw) in the range of 4,000 to 18,000, an acid value (AV) in the range of 60 to 200 and an oxygen content of at least 15 wt %,
B) A base polymer with an oxygen content of at least 12 wt %;

Wherein the acidic polymer may be presented in the range of 20 wt % to 70 wt %, based on the total dry weight of the waterborne emulsion, and the theoretical acid value (TAV) of the waterborne emulsion is in the range of 15 to 60.

In one aspect, the acidic polymer stabilizer includes a polymerization product of a mixture comprising at least one hydrophobic monoethylenically unsaturated monomer and at least one hydrophilic monoethylenically unsaturated monomer, where the polymer stabilizer is water soluble upon neutralization; the polymer stabilizer shall have a Mw in the range of 4,000 to 18,000; an acid value from 60 to about 200 and an oxygen content of at least 15 wt %.

The at least one hydrophobic monoethylenically unsaturated monomer may be selected from the group consisting of (meth)acrylate monomers, (meth)acrylonitrile monomers, styrene monomers, vinyl alkanoate monomers and monoethylenically unsaturated di- and tricarboxylic ester monomers.

Particularly, the (meth)acrylate monomers may be C₁-C₁₉-alkyl (meth)acrylates, for example, but not limited to, methyl (meth)acrylate, ethyl (meth)acrylate, n-butyl (meth)acrylate, 2-ethylhexyl (meth)acrylate, cyclohexyl (meth)acrylate, n-octyl (meth)acrylate, n-decyl (meth)acrylate, n-dodecyl (meth)acrylate (i.e. lauryl (meth)acrylate), tetradecyl (meth)acrylate, oleyl (meth)acrylate, palmityl (meth)acrylate, stearyl (meth)acrylate, isobornyl (meth)acrylate, benzyl (meth)acrylate, phenyl (meth)acrylate and a mixture thereof.

Particularly, the styrene monomers may be unsubstituted styrene or C1-C6-alkyl substituted styrenes, for example, but not limited to, styrene, α-methylstyrene, ortho-, meta- and para-methylstyrene, ortho-, meta- and para-ethylstyrene, o,p-dimethylstyrene, o,p-diethylstyrene, ispropylstyrene, o-methyl-p-isopropylstyrene or any mixture thereof.

Particularly, the vinyl alkanoate monomers may be vinyl esters of C₂-C₁₁-alkanoic acids, for example, but not limited to, vinyl acetate, vinyl propionate, vinyl butanoate, vinyl valerate, vinyl hexanoate, vinyl versatate or a mixture thereof.

In addition, the monoethylenically unsaturated di- and tricarboxylic ester monomers may be full esters of monoethylenically unsaturated di- and tricarboxylic acids, for example, but not limited to, diethyl maleate, dimethyl fumarate, ethyl methyl itaconate, or any mixture thereof.

In a preferred embodiment according to the present invention, one or more C₁-C₁₂-alkyl (meth)acrylates, such as methyl (meth)acrylate, ethyl (meth)acrylate, n-butyl (meth)acrylate and 2-ethylhexyl (meth)acrylate, styrene or a mixture thereof is chosen as the at least one hydrophobic monoethylenically unsaturated monomer.

The hydrophobic monomer may account for, based on the total weight of the acidic polymer stabilizer, at least 85 wt %, preferably at least 90 wt %, more preferably at least 95% by weight.

The at least one hydrophilic monoethylenically unsaturated monomer may be monoethylenically unsaturated monomers containing at least one functional group selected from the group consisting of carboxyl, carboxylic anhydride, sulfonic acid, phosphoric acid, hydroxyl and amide.

Particularly, the hydrophilic monoethylenically unsaturated monomer includes, but is not limited to, monoethylenically unsaturated carboxylic acids, such as (meth)acrylic acid, itaconic acid, fumaric acid, citraconic acid, sorbic acid, cinnamic acid, glutaconic acid and maleic acid; monoethylenically unsaturated carboxylic anhydride, such as itaconic acid anhydride, fumaric acid anhydride, citraconic acid anhydride, sorbic acid anhydride, cinnamic acid anhydride, glutaconic acid anhydride and maleic acid anhydride; monoethylenically unsaturated amides, especially N-alkylolamides, such as (meth)acrylamide, N-methylol (meth)acrylamide, 2-hydroxyethyl (meth)acrylamide; and hydroxyalkyl esters of monoethylenically unsaturated carboxylic acids, such as hydroxyethyl (meth)acrylate and hydroxypropyl (meth)acrylate.

In a preferred embodiment according to the present invention, acrylic acid, methacrylic acid, itaconic acid, acrylamide, methacrylamide or a mixture thereof is preferred as the at least one hydrophilic monoethylenically unsaturated monomer.

The hydrophilic monomer may account for, based on the total weight of the acidic polymer stabilizer, at least 0.2 wt % and no more than 15 wt %, preferably at least 0.5 wt % and no more than 10 wt %, and more preferably at least 1 wt % and no more than 5 wt %.

In one embodiment, the monomer mixture for the acidic polymer stabilizer includes at least two (meth)acrylates selected from ethyl acrylate, ethyl methacrylate, methyl methacrylate, vinyl acetate, methyl acrylate, 2-ethylhexyl (meth)acrylate, 2-hydroxyethyl methacrylate, 2-hydroxyethyl acrylate, glycidyl acrylate, glycidyl methacrylate, propyl acrylate, propyl methacrylate, (polyethylene glycol) methyl ether acrylate, or (polyethylene glycol) methyl ether methacrylate; and at least one a (meth)acrylic acid selected from acrylic acid, methacrylic acid, itaconic acid, maleic acid, fumaric acid, and crotonic acid. In a preferred embodiment, the monomer mixture for the acidic polymer stabilizer includes methyl methacrylate, styrene, 2-ethylhexyl (meth)acrylate and acrylic acid.

In addition, the acidic polymer stabilizer may be synthesized with the presence of at least one chain transfer agent. Chain transfer agents are frequently used to regulate the molecular weight of polymers. Chain transfer agents may include, but not limited to, compounds containing a thiol group, for example mercaptans, such as without limitation, ethyl mercaptan, n-propyl mercaptan, n-butyl mercaptan, isobutyl mercaptan, t-butyl mercaptan, n-amyl mercaptan, isoamyl mercaptan, t-amyl mercaptan, n-hexyl mercaptan, cyclohexyl mercaptan, n-octyl mercaptan, n-decyl mercaptan, n-dodecyl mercaptan, mercapto carboxylic acids and their esters, such as without limitation, 2-ethylhexyl thioglycolate, methyl mercaptopropionate and 3-mercaptopropionic acid, alcohols, such as isopropanol, isobutanol, lauryl alcohol and t-octyl alcohol, halogenated compounds such as carbon tetrachloride, tetrachloroethylene, tricholoro-bromoethane, and any combination thereof.

The chain transfer agent may be added in an amount of, based on the total weight of the acidic polymer stabilizer, no more than 1 wt %, preferably no more than 0.5 wt %, and more preferably no more than 0.2 wt %.

The acidic polymer stabilizer may have a Mw in the range of 4,000 to 18,000, preferably in the range of 5,000 to 13,000, and most preferably in the range of 5,000 to 12,000.

The acid value (AV) of the acidic polymer stabilizer may be in the range of 60 to 200, preferably in the range of 65 to 180, more preferably in the range of 70 to 160, and mostly preferably in the range of 75 to 150.

The acidic polymer stabilizer may have an oxygen of at least 15 wt %, preferably at least 18 wt %, more preferably at least 20 wt %, and most preferably at least 22 wt %.

The base polymer according to the present invention may be synthesized with a mixture comprising at least one hydrophobic monoethylenically unsaturated monomer and at least one hydrophilic monoethylenically unsaturated monomer. The hydrophobic monoethylenically unsaturated monomer and the hydrophilic monoethylenically unsaturated monomer may or may not be the same as that for the acidic polymer stabilizer. There is no specific limitation and/or preference over the monomer that can be used. For example, methyl (meth)acrylate, ethyl (meth)acrylate, n-butyl (meth)acrylate and 2-ethylhexyl (meth)acrylate, styrene or a mixture thereof is chosen as the at least one hydrophobic monoethylenically unsaturated monomer may be chosen as the at least one hydrophobic monoethylenically unsaturated monomer while acrylic acid, methacrylic acid, itaconic acid, acrylamide, methacrylamide or a mixture thereof is preferred as the at least one hydrophilic monoethylenically unsaturated monomer.

The hydrophobic monomer may account for, based on the total weight of the base polymer, at least 85 wt %, preferably at least 90 wt %, more preferably at least 95% by weight. And, the hydrophilic monomer may account for, based on the total weight of the acidic polymer stabilizer, at least 0.2 wt % and no more than 15 wt %, preferably at least 0.5 wt % and no more than 10 wt %, and more preferably at least 1 wt % and no more than 5 wt %.

The monomers for the base polymer of the present invention may further comprise one or more crosslinking monomers. The crosslinking monomers can be chosen from di- or poly-isocyanates, polyaziridines, polycarbodiimide, polyoxazolines, glyoxals, triols, epoxy molecules, organic silanes, carbamates, diamines and triamines, hydrazides, carbodiimides and multi-ethylenically unsaturated monomers. In the present invention, suitable crosslinking monomers include, but not limited to, glycidyl (meth)acrylate, N-methylol(meth)acrylamide, (isobutoxymethyl)acrylamide, vinyltrialkoxysilanes such as vinyltrimethoxysilane; alkylvinyldialkoxysilanes such as dimethoxymethylvinylsilane; (meth)acryloxyalkyltrialkoxysilanes such as (meth)acryloxyethyltrimethoxysilane, (3-acryloxypropyl)trimethoxysilane and (3-methacryloxypropyl)trimethoxysilane, allyl methacrylate, diallyl phthalate, 1,4-butylene glycol dimethacrylate, 1,2-ethylene glycol dimethacrylate, 1,6-hexanediol diacrylate, divinyl benzene or any mixture thereof.

The crosslinker can be added in an amount of no more than 10% by weight, preferably no more than 8% by weight, more preferably no more than 5% by weight, based on the total weight of the base polymer.

Without bonding to any specific theory, lower oxygen content of the base polymer will deteriorate the alcohol tolerance performance of the waterborne emulsion. Therefore, the base polymer shall have an oxygen content of at least 12 wt %, preferably at least 15 wt %, and more preferably at least 20 wt %.

The base polymer may have a weight average molecular weight (Mw) in the range of 5,000 to 3,000,000, preferably from 10,000 to 100,000, and more preferably from 15,000 to 50,000.

There is no specific limitation on the glass transition temperature (Tg) of the base polymer. For example, Tg of the base polymer may be in the range of −60 to 120° C., or in the range of −40 to 60° C., or in the range of −20 to 0° C.

Within the context of the present application, the term Fox Tg refers to a glass transition temperature (Tg) as calculated according to the following Fox equation as disclosed in T. G. Fox, Bulletin of the American Physical Society, Volume 1, Issue No. 3, page 123 (1956):

1/Tg=W₁/Tg₁+W₂/Tg₂+ . . . +Wₙ/Tgₙ

wherein

W₁, W₂, . . . Wₙ, are the mass fractions of the monomers 1, 2, . . . n, respectively, and

Tg₁, Tg₂, . . . Tgₙ, are the glass transition temperatures of homopolymers of the monomers 1, 2, . . . n in degrees Kelvin, respectively.

The Tg values for homopolymers of the majority of monomers are known and are listed in, for example, Ullmann's Encyclopedia of Industrial Chemistry, Vol. 5, Vol. A21, page 169, VCH Weinheim, 1992. Other sources of glass transition temperatures of homopolymers include, for example, J. Brandrup, E. H. Immergut, Polymer Handbook, 1st Edition, J. Wiley, New York 1966, 2nd Edition, J. Wiley, New York 1975, and 3rd Edition, J. Wiley, New York 1989.

According to the present invention, the acidic polymer may be presented in the range of 15 wt % to 70 wt %, preferably in the range of 20 wt % to 65 wt %, more preferably in the range of 25 wt % to 60 wt %, based on the total dry weight of the waterborne emulsion.

According to the present invention, the theoretical acid value (TAV) of the waterborne emulsion is in the range of 15 to 60, preferably in the range of 18 to 55, more preferably in the range of 20 to 50.

In one embodiment of the present invention, the acidic polymer may be presented in the range of 15 wt % to 70 wt %, based on the total dry weight of the waterborne emulsion, and the theoretical acid value (TAV) of the waterborne emulsion is in the range of 15 to 60.

In one embodiment of the present invention, the acidic polymer may be presented in the range of 20 wt % to 65 wt %, based on the total dry weight of the waterborne emulsion, and the theoretical acid value (TAV) of the waterborne emulsion is in the range of 18 to 55.

In one embodiment of the present invention, the acidic polymer may be presented in the range of 25 wt % to 60 wt %, based on the total dry weight of the waterborne emulsion, and the theoretical acid value (TAV) of the waterborne emulsion is in the range of 20 to 50.

In another aspect, a process of preparing a waterborne polymer emulsion is provided. Many of the common emulsion polymerization methods known to the skilled person in the art may be applied. There is no specific limitation on the method to be used according to the present invention. The emulsion polymerization may be conducted either as a batch operation or in the form of a feed process (i.e. the reaction mixture is fed into the reactor in a staged or gradient procedure). Feed process is a preferred process. The waterborne polymer emulsion may be synthesized with a single-stage polymerization (i.e. all the monomers added in one stage) or multi-stage polymerization (i.e. polymerization of the first-stage monomers resulting the first-stage polymer and subsequent the second-stage monomers resulting the second stage polymer). The acid polymer stabilizer may be added to the reactor at the beginning of the polymerization process or continuously added into the reactor together with the monomer feeding.

The emulsion polymerization may be carried out in the presence of various common initiating systems, including but not limited to a thermal or redox initiator. The initiator is usually used in an amount of no more than 10% by weight, preferably 0.02 to 5% by weight, more preferably 0.1 to 1.5 wt %, based on the total weight of the base polymers.

Thermal initiators, such as peroxides, persulfates and azo compounds, may be used for the present invention. Peroxides, which may be used include, but are not limited to, inorganic peroxides, such as hydrogen peroxide, or peroxodisulfates, or organic peroxides, such as tert-butyl, p-menthyl or cumyl hydroperoxide, tert-butyl perpivalate, and dialkyl or diaryl peroxides, such as di-tert-butyl or di-cumyl peroxide. Azo compounds which may be used, include, but not limited to, 2,2″-azobis(isobutyronitrile), 2,2″-azobis(2,4-dimethylvaleronitrile). Among others, sodium persulfate (SPS), potassium persulfate (KPS), ammonium persulfate (APS), 2,2″-azobis(amidinopropyl) dihydrochloride (AIBA, V-50 TM), and 4,4′-azobis(4-cyanovaleric acid) (ACVA, V501) are preferred as the thermal initiator.

A redox initiator, which usually comprises an oxidizing agent and a reducing agent may also be used. Suitable oxidizing agents include the abovementioned peroxides. Suitable reducing agents may be alkali metal sulfites, such as potassium and/or sodium sulfite, or alkali metal hydrogensulfites, such as potassium and/or sodium hydrogensulfite. Preferable redox initiators include an oxidizing agent selected from the group consisting of t-butylhydroperoxide and hydrogen peroxide, and a reducing agent selected from ascorbic acid, sodium formaldehyde sulfoxylate, sodium acetone bisulfite and sodium metabisulfite (sodium disulfite).

In a polymerization process of the present invention, most surfactants known to the skilled person in the art may be used. Surfactant to be used according to the present invention may be a non-reactive surfactant, a reactive surfactant or a combination thereof. Surfactants may be formulated together with the monomers and fed into a reaction reactor. Alternatively, the surfactants may be added into the reaction medium first followed by the feeding of monomers. Surfactants may be used in a suitable amount known to the skilled person in the art, for example, in a total amount of 0.1% to 6% by weight, based on the total weight of the monomers.

Surfactants may be non-reactive anionic and/or nonionic surfactants. Suitable non-reactive anionic surfactants, for example, include, but are not limited to, alkyl, aryl or alkylaryl sulfate salts, sulfonate salts or phosphate salts; alkyl sulfonic acids; sulfosuccinate salts; fatty alcohol ether sulfate salts and fatty acids. Suitable non-reactive nonionic surfactants for example include alcohol or phenol ethoxylates such as polyoxyethylene alkylphenyl ether.

Surfactants may also be polymerizable surfactants, also called reactive surfactants, containing at least one ethylenically unsaturated functional group. Suitable polymerizable surfactants for example include, but are not limited to, allyl polyoxyalkylene ether sulfate salts such as sodium salts of allyl polyoxyethylene alkyl ether sulfate, allyl alkyl succinate sulfonate salts, allyl ether hydroxyl propanesulfonate salts such as sodium salts, polyoxyethylene styrenated phenyl ether sulfate salts such as ammonium salts, for example DKS Hitenol AR 1025 and DKS Hitenol AR 2020, polyoxyethylene alkylphenyl ether sulfate ammonium salts, polyoxyethylene allyloxy nonylphenoxypropyl ether, and phosphate acrylates such as SIPOMER PAM 100, phosphate acrylates such as SIPOMER PAM 200, etc.

The polymerization may be carried out and maintained at a temperature lower than 100° C. throughout the course of the reaction. Preferably, the polymerization is carried out at a temperature between 60° C. and 95° C. Depending on various polymerization conditions, the polymerization may be carried out for several hours, for example 2 to 8 hours.

The water-borne emulsion may be applied as inks, coatings, etc. The emulsion can be formulated with crosslinking agents, solvents, pigments, dispersion agents, wetting agents, defoamers and other useful additives when applied as inks.

Illustrative crosslinking agents include, but are not limited to, aziridines, carbodiimides, oxazolines, zinc compounds, zirconium compounds, etc.

Suitable solvents include a wide range of solvents for emulsion coatings, including water, alcohols, etc.

Suitable dispersion agent includes, but are not limited to polyvinyl alcohols, polyacrylic acid, acrylic acid-acrylonitrile copolymers, vinyl acetate-acrylate copolymers, acrylic acid-acrylate copolymers, styrene-acrylic acid copolymers, styrene-methacrylic acid copolymers, styrene-methacrylic acid-acrylate copolymers, styrene-alpha methyl styrene-acrylic acid copolymers, styrene-alpha methyl styrene-acrylic acid-acrylate copolymers, styrene-maleic acid copolymers, styrene-maleic anhydride copolymers, vinyl naphthalene-acrylic acid copolymers, vinyl naphthalene-maleic acid copolymers, vinyl acetate-maleate copolymers, vinyl acetate-crotonic acid copolymers, and vinyl acetateacrylic acid copolymers, and the salts thereof. The copolymers can be used in any form of random copolymer, block copolymer, alternating copolymer and graft copolymer. Specific dispersion agents may include Dispex AA 4140, Dispex AA 4141, Dispex CX 4320, Dispex Ultra PX 4525, Dispex Ultra PX 4575, Dispex Ultra PX 4290, Dispex Ultra PX 4585, Dispex Ultra PA 4590 (EFKA-4590) (From BASF); Tego dispers 715W, Tego dispers 740W, Tego dispers 747W, Tego dispers 750W, Tego dispers 752W, Tego dispers 755W, Tego dispers 757W, Tego dispers 760W, Tego dispers 761W, Zetasperse 182 (From EVONIK); Disper BYK 190, Disper BYK 192, Disper BYK 193, Disper BYK 192, Disper BYK 2012, Disper BYK 2013 (From BYK); Silcosperse HLD-5, HLD-6, HLD-8/A, HLD-8/B, HLD-9/A, HLD-9/M, HLD-11, HLD-11/C (From Silcona GmbH&CO.KG); and Solsperse 27,000, 40,000, 44,000, 46,000 and 47,000 (from Lubrizol).

Wetting agents may be selected from Hydropalat WE3221, Hydropalat WE3322, Hydropalat WE3323, Hydropalat WE3475, Hydropalat WE3485, Hydropalat WE3650 (From BASF); Dynol 604, Dynol 810, Surfynol 104E, Surfynol 420, Surfynol 440, Tego Twin 4000, Tego Twin 4100, Tego twin 4200, Tego Wet 240, Tego Wet 270, Tego Wet 500, Tego Wet 510, Tego Wet KL 245 (From EVONIK); and BYK-DYNWET 800 N, BYK-347 (From BYK).

Defoamers may be selected from FoamStar SI 2210, FoamStar SI 2240, FoamStar SI 2250, FoamStar SI 2292, FoamStar ST 2438 (From BASF); Tego Airex 901 W, Tego Foamex 1488, Tego Foamex 3062, Tego Foamex 805N, Tego Foamex 810, Tego Foamex 822, Tego Foamex 832, Tego Foamex 835, Tego Foamex 840, Tego Foamex 842, Tego Foamex 843, Tego Foamex 844, Tego Foamex 845, Tego Foamex 1497 (From EVONIK); and BYK-016, BYK-017, BYK-021, BYK-024, BYK-028, BYK-094 (From BYK).

Other useful additives may include rheology additive, such as Rheovis PU 1214, Rheovis PU 1215, Rheovis PU 1250, Rheovis PU 1251 (From BASF), Tego Viscoplus 3000, Tego Viscoplus 3030, Tego Viscoplus 3060 (From EVONIK), and Rheobyk-425, Rheobyk-7420 ES (From BYK), waxes, such as Joncryl wax 4, Joncryl wax 26, Joncryl wax 35, Joncryl wax 120 (From BASF) and Aquacer 497, Aquacer 532, Aquacer 539, Aquacer 593 (From BYK), and slipping agent such as Tego Glide 100, Tego Glide 110, Tego Glide 410, Tego Glide 435, Tego Glide 490, Tego Glide 492, Tego Glide 494, Tego Glide 496 (From EVONIK) and Dow corning DC51, Dow corning DC57 (From Dow).

The inks according to the present invention may comprise pigments, such as organic and inorganic pigments. Examples of such pigments include but not limited to Pigment White 6 (Titanium Dioxide), Pigment Black 7 (carbon black), Pigment Black 11 (Black Iron Oxide), Pigment Red 101 (Red Iron Oxide) and Pigment Yellow 42 (Yellow Iron Oxide), Pigment Yellow 1, Pigment Yellow 37, Pigment Yellow 83, Pigment Yellow 106, Pigment Yellow 114, Pigment Orange 5, Pigment Orange 34, Pigment Red 2, Pigment Red 14, Pigment Red 23, Pigment Red 42, Pigment Red 112, Pigment Red 146, Pigment Red 210, Pigment Base Cyan 192, Pigment Blue 15, Pigment Green 7, Pigment Green 36, Pigment Violet 23 and others. Any combination of the abovementioned pigment may be used.

The water-borne dispersions according to the present invention are very useful as or for producing formulations for flexographic, gravure or ink-jet printing. Useful substrate materials Include, but not limited to, cellulosic materials such as paper, board, card, wood and woodbase, which may each be lacquered or otherwise coated, metallic materials such as foils, sheets or workpieces composed of aluminum, iron, copper, silver, gold, zinc or alloys thereof, which may each be lacquered or otherwise coated, silicatic materials such as glass, porcelain and ceramic, which may each be coated, polymeric materials of any kind such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers including block copolymers, biodegradable polymers, e.g. polylactic acid, and natural polymers such as gelatin, leather-both natural and artificial—in the form of smooth leather, nappa leather or suede leather.

Plastics particularly worth highlighting include polycarbonate, polyethylene, for example PE, HDPE, LDPE, polypropylene, for example PP, oriented PP (OPP), biaxially oriented PP (BOPP), polyamide, for example Nylon, and polyethylene terephthalate (PET) or PVC.

The present technology, thus generally described, will be understood more readily by reference to the following example, which is provided by way of illustration and is not intended to limit the present technology.

### Examples

### Preparation of the Acidic Polymer Stabilizer (“APS”)

Monomers (as indicated in Table 1) were first weighed out in appropriate amounts and mixed with a solvent to form a clear solution. Di-tert-amyl peroxide (DTAP, 0.5 wt % based on the total amount of monomers) was added to the mixture and mixed until the entire solution was clear. The solution was then fed to a continuous stirred tank reactor operating a 160° C. and product continuously withdrawn so as to maintain an appropriate residence time (about 15 min) in the reactor. The product from the reactor was continuously charged to an evaporated operating at elevated temperature and under vacuum to remove unreacted monomer and solvent from the resin product. The resin product was then analyzed for molecular weight and acid value. The composition of the polymer was estimated by either assuming it was identical to the composition of the monomers in the feed, or by mass balance on the individual monomers fed to the reactor. Oxygen content was calculated from the computed polymer composition.

TABLE 1
Summary of Polymerization Results for Making the Acidic Polymer Stabilizer

| | AA | MAA | ST | AMS | MMA | 2-EHA | BA | Mw | AV | O₂ |
|---|---|---|---|---|---|---|---|---|---|---|
| APS1 | 10 | | 25 | | 55 | 10 | | 9.0 | 83 | 23.5 |
| APS2 | 10 | | 28 | | 50 | 12 | | 9.6 | 78 | 22.5 |
| APS3 | 9.5 | | 25 | | 55 | 10.5 | | 14.7 | 74 | 23.6 |
| APS4 | | 19 | | | 64 | | 17 | 8.0 | 125 | 31.4 |
| APS5 | 6.7 | | 24.3 | | 65 | | 4 | 13.8 | 55 | 24.7 |
| APS6 | 29 | | 35 | 30 | | | 6 | 8.8 | 221 | 15.6 |
| APS7 | 18 | | 54 | 17 | 9 | 2 | | 11.1 | 146 | 11.1 |

AA = acrylic acid (in wt %, based on the total weight of monomers);
MAA = methyl acrylic acid (in wt %, based on the total weight of monomers);
ST = styrene (in wt %, based on the total weight of monomers);
AMS = alpha methyl styrene (in wt %, based on the total weight of monomers);
MMA = methyl methacrylate (in wt %, based on the total weight of monomers);
2-EHA = 2-ethyl hexyl acrylate (in wt %, based on the total weight of monomers);
BA = butyl acrylate (in wt %, based on the total weight of monomers)
AA (in wt %) + MAA (in wt %) + ST (in wt %) + AMS (in wt %) + MMA (in wt %) + 2-EHA (in wt %) + BA (in wt %) = 100%
Mw is the weight average molecular weight (in KDa)
AV = Acid Value
O₂ = Oxygen content

### Typical Procedure to Make an Acidic Polymer Stabilizer Solution (“APS Solution”)

De-ionized water (667.5 g) and 300 g of a dry acidic polymer stabilizer from Table 1 were charged into a 2 L reactor. An ammonia solution (28% solution in water, 32.5 g) was added to the reactor with stirring at room temperature in 10 minute. The reactor was heated to a temperature of 60° C., and stirred for 2 hours at 60° C. The solution was then cooled to room temperature and filtered to produce. The final acidic polymer stabilizer solution (APS solution) has a pH of about 8.3 and a solid content of about 30 wt %.

### Typical Procedure to Prepare a Waterborne Emulsion

De-ionized water (339.7 g), APS solution (291.4 g) as listed in Table 2, Disponil LDBS (7.78 g) were charged into a 2 L reactor and heated to 85° C. with stirring. Ammonium persulfate (1.73 g) was added with water (6.94 g). A monomer mixture as listed in Table 2 (with a total weight of 349.45 g) was fed slowly into the reactor over 60 minutes. Afterwards, it was cooled to 40° C., A biocide (3 g) was added at the end.

The final emulsion has a pH of about 8.2 and a solid content of about 44 wt %.

TABLE 2
Summary of the Synthesis of the waterborne emulsion

| | APS | Monomers | | | | |
|---|---|---|---|---|---|---|
| | solution Type | St* | MMA* | BA* | EHA* | DAAM* |
| WD 1 | APS1 | | 24.4 | 73.3 | | 2.3 |
| | Solution | | | | | |
| WD 2 | APS1 | | 24.4 | 73.3 | | 2.3 |
| | Solution | | | | | |
| WD 3 | APS2 | | 24.4 | 73.3 | | 2.3 |
| | Solution | | | | | |
| WD 4 | APS3 | | 24.4 | 73.3 | | 2.3 |
| | Solution | | | | | |
| WD 5 | APS4 | | 24.4 | 73.3 | | 2.3 |
| | Solution | | | | | |
| WD 6 | APS1 | | 11.0 | 88.0 | | 1.0 |
| | Solution | | | | | |
| WD 7 | APS1 | 10.0 | | 88.0 | | 2.0 |
| | Solution | | | | | |
| WD 8 | APS1 | 24.0 | 24.0 | 50.0 | | 2.0 |
| | Solution | | | | | |
| WD 9 | APS1 | 25.0 | 60.0 | 15.0 | | |
| | Solution | | | | | |
| WD 10 | APS1 | 50.0 | 50.0 | | | |
| | Solution | | | | | |
| WD 11 | APS1 | 50.0 | 48.0 | | | 2.0 |
| | Solution | | | | | |
| WD 12 | APS4 | 35.0 | | | 62.7 | 2.3 |
| | Solution | | | | | |
| WD 13 | APS7 | | 24.4 | 73.3 | | 2.3 |
| | Solution | | | | | |
| WD 14 | APS5 | 12.0 | 5.8 | 80.3 | | 1.9 |
| | Solution | | | | | |
| WD 15 | APS6 | 7.0 | 3.1 | 88.0 | | 1.9 |
| | Solution | | | | | |
| WD 16 | APS1 | 24.0 | | 72.0 | | 4.0 |
| | Solution | | | | | |
| WD 17 | APS1 | 24.0 | | 72.0 | | 4.0 |
| | Solution | | | | | |

*Weight percentage based on the total weight of monomers

### Typical Ink Formulation

A mixture of 44.2 g of J HPD 196 Black pigment (from BASF), 45.3 g of a waterborne emulsion, 0.3 g of Hydropalat® WE3221 (from BASF), 0.5 g of Hydropalat® WE3650 (from BASF), 0.5 g of Dowsil 51 (from Dow), 0.5 g of ethanol, Joncryl® Wax 35 (from BASF), 2.75 g of isopropanol alcohol, 0.1 g of Foamstar® SI 2438 (from BASF) and 2.85 g of D.I. water were mixed together vigorously.

### Alcohol Tolerance Test

An ink formulation was mixed with ethanol at a ratio of 2:1 (wt/wt) and stirred for 5 min at a speed of about 600 rpm. Then, the mixture was subjected to visual examination and viscosity check. The following stand has been used to assess the alcohol tolerance test performance. Viscosity change means (Viscosity_{ink formulation with ethanol}−Viscosity_{ink formulation})/Viscosity_{ink formulation}. The viscosity is measured with a Zahn 2 #Cup (from Sheen company). For each ink, two independent tests were performed and an average rating was taken as the final rating.

Alcohol tolerance rating

| Rating | Description of rating |
|---|---|
| 5 | The ink is homogeneous and the viscosity change is |
| | less than 80%. |
| 4 | The ink is homogeneous and the viscosity change is |
| | 80 to 200%. |
| 3 | The ink is homogeneous and the viscosity change is |
| | more than 200%. |
| 2 | The ink has obvious gel, but most part is still flowable. |
| 1 | The ink has serious and obvious gel, no flowability. |

### Wet Wrinkle Resistance Test

An ink was drawn down onto BOPP (from FuRongHui BOPP Company, with a thickness of 18 micrometer) with a 2 #K-bar. The coated BOPP substrate was dried at 50° C. for 30 second and then kept at room temperature for 24 h. There is roughly 4 g/m² ink (dry weight) on the BOPP. The substrate was folded in a concertina manner for 5 times. The folded part was wrinkled for 10 seconds with both hands under cold (approx. 10° C.) running tap water. Afterwards, the substrate was carefully dried and the lose of ink was recorded. The wet wrinkle resistance performance was assessed according to the following criteria.

Wet wrinkle resistance test rating

| Rating | Description of rating |
|---|---|
| 5 | More than 90% of the ink was retained after wrinkling. |
| 4 | More than 60% and no more than 90% of the ink was |
| | retained after wrinkling. |
| 3 | More than 40% and no more than 60% of the ink was |
| | retained after wrinkling. |
| 2 | More than 10% and no more than 40% of the ink was |
| | retained after wrinkling. |
| 1 | No more than 10% of the ink was retained after wrinkling. |

To meet the performance requirement, the ink must have a alcohol tolerance test rating of 3 and a wet wrinkle resistance test of 3.

The overall waterborne emulsion information and the corresponding ink performance data is summarized in Table 3.

TABLE 3
The waterborne emulsion information and
the corresponding ink performance data

| | | | Base | Base | | | |
|---|---|---|---|---|---|---|---|
| | APS | APS | Polymer | Polymer | | Alcohol | Wet |
| | Type | %* | Tg | Oxygen % | TAV | Tolerance | Wrinkle |
| Ink 1 | APS1 | 30% | −11.2 | 26.57% | 24.9 | 5 | 4 |
| Ink 2 | APS1 | 20% | −11.2 | 26.57% | 16.6 | 4 | 4 |
| Ink 3 | APS2 | 30% | −11.2 | 26.57% | 23.4 | 4.5 | 4 |
| Ink 4 | APS3 | 30% | −11.2 | 26.57% | 22.2 | 4 | 4 |
| Ink 5 | APS4 | 33% | −11.2 | 26.57% | 41.3 | 5 | 4 |
| Ink 6 | APS1 | 30% | −47.0 | 19.02% | 24.9 | 5 | 4 |
| Ink 7 | APS1 | 30% | −30.0 | 22.38% | 24.9 | 5 | 4 |
| Ink 8 | APS1 | 30% | 20.0 | 20.56% | 24.9 | 5 | 4 |
| Ink 9 | APS1 | 30% | 64.0 | 22.95% | 24.9 | 5 | 4 |
| Ink 10 | APS1 | 30% | 100.0 | 16.00% | 24.9 | 5 | 4 |
| Ink 11 | APS1 | 30% | 100.0 | 15.74% | 24.9 | 5 | 4 |
| Ink 12 | APS4 | 33% | −10.2 | 11.34% | 41.3 | 2 | 3.5 |
| Ink 13 | APS7 | 30% | −11.2 | 26.57% | 43.8 | 1 | 2 |
| Ink 14 | APS5 | 30% | −20.1 | 22.29% | 16.5 | 2 | 4 |
| Ink 15 | APS6 | 30% | −29.9 | 23.35% | 66.3 | 1 | 2 |
| Ink 16 | APS1 | 15% | −9.9 | 18.76% | 12.5 | 2 | 5 |
| Ink 17 | APS1 | 80% | −9.9 | 18.76% | 66.4 | 5 | 1.0 |

*means the weight ratio of APS (dry weight) over the total weight of APS and base polymer (dry weight)

It's obvious that many different acidic polymer may be applied to make the waterborne emulsion based ink (Ink 1 and Ink 3-5) and the acidic polymer may be combined with base polymers with different Tg (Ink 6 to Ink 11). However, the oxygen content of both the base polymer and acidic polymer can not be too low (Ink 12 and Ink 13, respectively). In addition, the acid value (AV) of the acidic polymer can not be too low (Ink 14) or too high (Ink 15). Meanwhile, the theoretical acid value (TAV) of the waterborne emulsion can not be too low (Ink 16) or too high (Ink 17), neither.

It will be apparent to those skilled in the art that various modifications and variations can be made in the present invention without departing from the scope or spirit of the invention. Thus, it is intended that the present invention cover such modifications and variations as come within the scope of the appended claims and their equivalents.

1. A waterborne emulsion comprising:
A) an acidic polymer stabilizer with a weight average molecular weight (Mw) in a range of 4,000 to 18,000, an acid value (AV) in a range of 60 to 200 and an oxygen content of at least 15 wt %; and
B) a base polymer with an oxygen content of at least 12 wt %,
wherein, optionally, the acidic polymer stabilizer is present in a range of 20 wt % to 70 wt %, based on a total dry weight of the waterborne emulsion, and a theoretical acid value (TAV) of the waterborne emulsion is in a range of 15 to 60.

2. The waterborne emulsion according to claim 1, wherein the acidic polymer stabilizer has a Mw in a range of 5,000 to 13,000.

3. The waterborne emulsion according to claim 1, wherein the acid value (AV) of the acidic polymer stabilizer is in a range of 65 to 180.

4. The waterborne emulsion according to claim 1, wherein the acidic polymer stabilizer has an oxygen content of at least 18 wt %.

5. The waterborne emulsion according to claim 1, wherein the base polymer has a weight average molecular weight (Mw) in a range of 5,000 to 3,000,000.

6. The waterborne emulsion according to claim 1, wherein the acidic polymer stabilizer is present in a range of 20 wt % to 65 wt %, based on the total dry weight of the waterborne emulsion.

7. The waterborne emulsion according to claim 1, wherein the theoretical acid value (TAV) of the waterborne emulsion is in a range of 18 to 55.

8. The waterborne emulsion according to claim 1, wherein the acidic polymer stabilizer is present in a range of 15 wt % to 70 wt %, based on the total dry weight of the waterborne emulsion, and the theoretical acid value (TAV) of the waterborne emulsion is in a range of 15 to 60.

9. The waterborne emulsion according to claim 1, wherein the acidic polymer stabilizer is present in a range of 20 wt % to 65 wt %, based on the total dry weight of the waterborne emulsion, and the theoretical acid value (TAV) of the waterborne emulsion is in a range of 18 to 55.

10. The waterborne emulsion according to claim 1, wherein the acidic polymer stabilizer is present in a range of 25 wt % to 60 wt %, based on the total dry weight of the waterborne emulsion, and the theoretical acid value (TAV) of the waterborne emulsion is in a range of 20 to 50.

11. A method for making a waterborne emulsion using the base polymer and the acidic polymer stabilizer according to claim 1, the method comprising synthesizing the base polymer in the presence of the acidic polymer stabilizer as.

12. An ink formulation comprising the waterborne emulsion according to claim 1.

13. The waterborne emulsion according to claim 1, wherein the acidic polymer stabilizer has a Mw in a range of 5,000 to 12,000.

14. The waterborne emulsion according to claim 1, wherein the acid value (AV) of the acidic polymer stabilizer is in a range of 70 to 160.

15. The waterborne emulsion according to claim 1, wherein the acidic polymer stabilizer has an oxygen content of at least 20 wt %.

16. The waterborne emulsion according to claim 1, wherein the base polymer has a weight average molecular weight (Mw) in a range of 10,000 to 100,000.

17. The waterborne emulsion according to claim 1, wherein the acidic polymer stabilizer is present in a range of 25 wt % to 60 wt %, based on the total dry weight of the waterborne emulsion.

18. The waterborne emulsion according to claim 1, wherein the theoretical acid value (TAV) of the waterborne emulsion is in a range of 20 to 50.

19. The waterborne emulsion according to claim 1, wherein the acid value (AV) of the acidic polymer stabilizer is in a range of 75 to 150.

20. The waterborne emulsion according claim 1, wherein the acidic polymer stabilizer has an oxygen content of at least 22 wt %.
